(19) United States
(12) Patent Application Publication
(10) Pub. No.: US 2007/0090150 A1
(43) Pub. Date: Apr. 26, 2007

(54) Component handling device

(76) Inventors: Karl Conrad, Rocklin, CA (US); Gregg Meyer, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,016

(22) Filed: Oct. 26, 2005

(51) Int. Cl. B23K 5/00; B23K 1/00; B23K 5/22

(52) U.S. Cl. 228/6.2; 228/6.1; 228/212

(57) ABSTRACT

A component handling device is disclosed. The component handling device includes a body with a component receiving portion that has a front region defining a first opening and a rear region defining a second opening. Also, the component receiving portion includes a component encasing wall extending from the first opening to the second opening. Additionally, a component elevating feature configured to assist with detaching the component from a substrate is coupled to the interior surface of the component encasing wall. In addition, a user gripping feature is coupled to the body of the component handling device. Moreover, a component bounding feature proximate to the second opening is coupled to the body to prevent the component from moving past the second opening. Furthermore, a component retaining feature is coupled to the interior surface of the component encasing wall for retaining the component when the component is placed within the component handling device.

The present invention relates to a component handling device and a method for forming a component handling device.

### BACKGROUND

For a variety of reasons, it may be difficult or even dangerous to manually detach a component from a substrate. For example, the component may be operating at a high temperature that makes manual detachment impossible. Alternatively, the location of the component may make it difficult to properly reach and detach the component by hand. Also, the attachment between the component and the substrate may be too strong to permit manual detachment.

Furthermore, detachment by hand poses a danger of harming both the component and the substrate when static electricity is a concern. Moreover, it is likely that the component may slip and fall during manual detachment, in which instance, both the component and the substrate may be damaged.

### SUMMARY

A component handling device is disclosed. The component handling device includes a body with a component receiving portion that has a front region defining a first opening and a rear region defining a second opening. Also, the component receiving portion includes a component encasing wall extending from the first opening to the second opening. Additionally, a component elevating feature configured to assist with detaching the component from a substrate is coupled to the interior surface of the component encasing wall. In addition, a user gripping feature is coupled to the body of the component handling device. Moreover, a component bounding feature proximate to the second opening is coupled to the body to prevent the component from moving past the second opening. Furthermore, a component retaining feature is coupled to the interior surface of the component encasing wall for retaining the component when the component is placed within the component handling device.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates a perspective view of a specific embodiment of the present invention.

FIG. 2 illustrates a bottom view of a specific embodiment of the present invention.

FIG. 3 illustrates a front view of a specific embodiment of the present invention.

FIG. 4A illustrates a specific embodiment of present invention in operation.

FIG. 4B illustrates a specific embodiment of present invention in operation.

FIG. 4C illustrates a specific embodiment of present invention in operation.

FIG. 5 illustrates a flow chart showing a method of manufacturing a component handling device.

### DETAILED DESCRIPTION

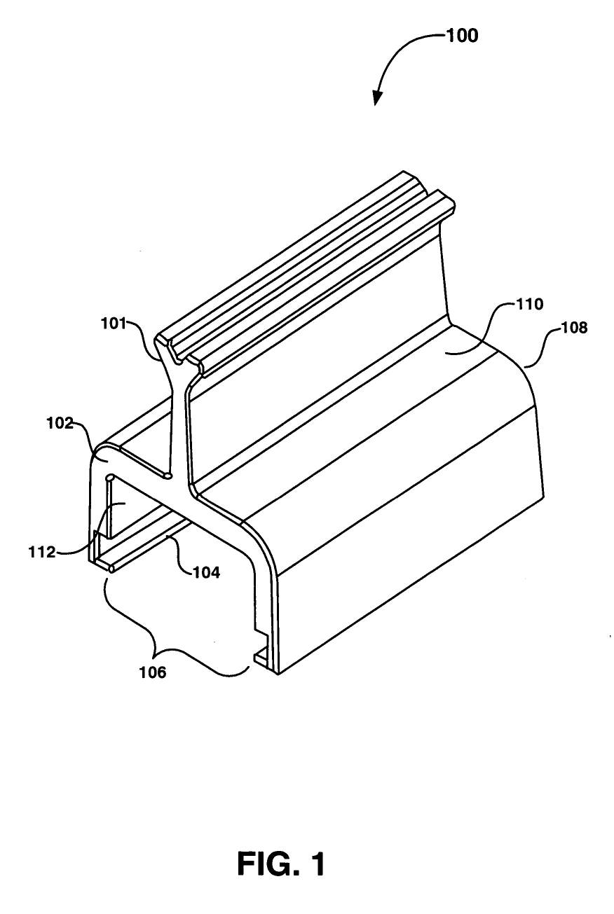

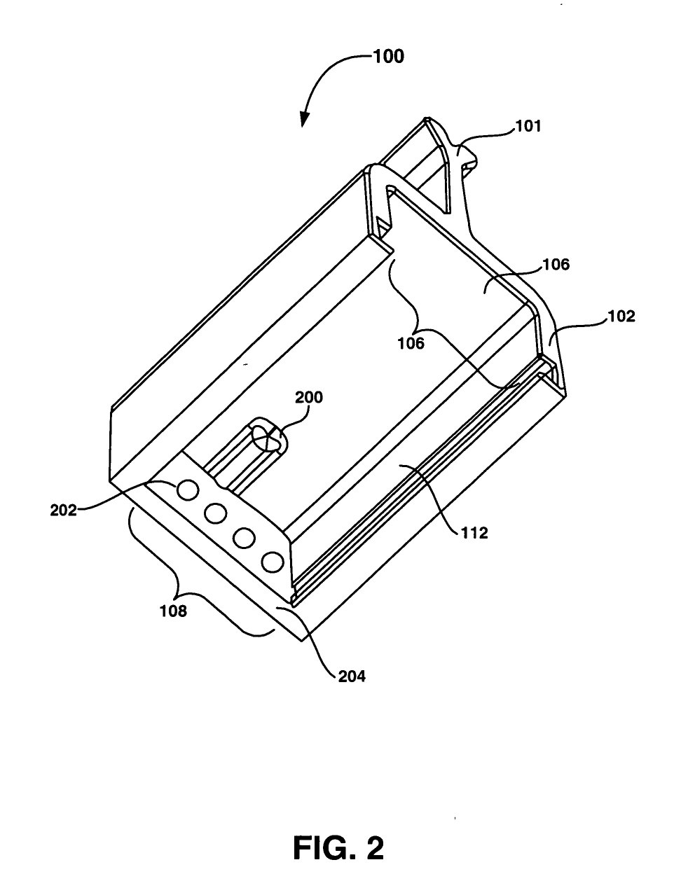

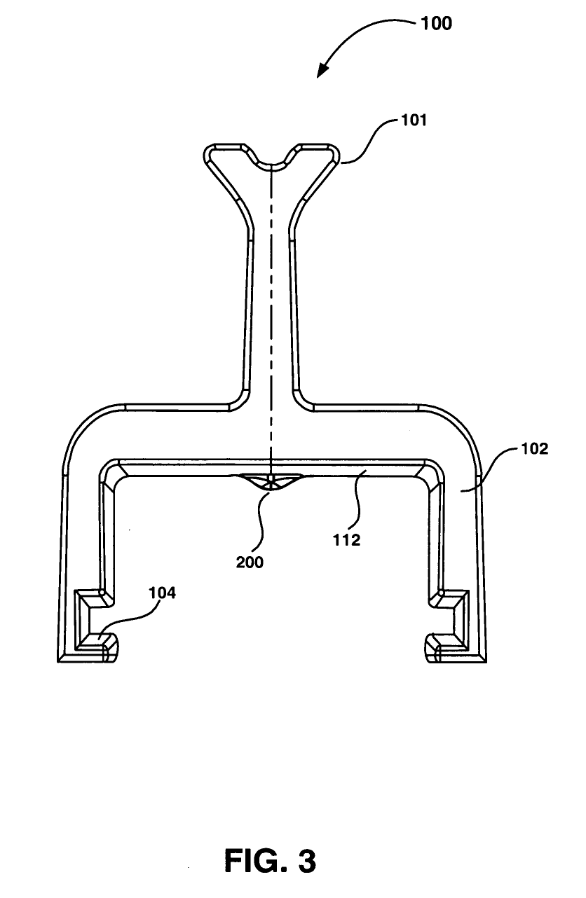

With reference now to FIG. 1, FIG. 2, and FIG. 3, a perspective view, a bottom view, and front view is shown of the component handling device 100 of the present invention. The following discussion will begin with a description of the physical structure of the present invention. This discussion will then be followed with a description of the operation of the present invention.

### Physical Structure

A component handling device 100 includes a body 110 that has a first opening 106 and a second opening 108. Also, a component encasing wall 102 extends from the first opening 106 to the second opening 108. Additionally, a component elevating feature 104 configured to assist with detaching a component from a substrate is coupled to the interior surface 112 of the component encasing wall 102. In addition, a user gripping feature 101 is coupled to the body 110 of the component handling device 100. Moreover, a component bounding feature 204 proximate to the second opening 108 is coupled to the body 110 to prevent a component from moving past the second opening 108. Furthermore, a component retaining feature 200 is coupled to the interior surface 112 of the component encasing wall 102 for retaining a component when a component is placed within the component handling device 100.

In one embodiment, the user gripping feature 101 is a Y-shaped handle coupled to the body 110. In another embodiment, the body 110 is comprised of a material that dissipates static charge. In another embodiment, the component handling device has airflow holes 202 positioned on the component bounding feature 204. In another embodiment, the component bounding feature 204 is a wall that partially covers the second opening 108. In another embodiment, the component retaining feature 200 is a detent coupled to the interior 5 surface 112 of the component encasing wall 102. In another embodiment, the component elevating feature 104 is an angled ramp coupled to but not integral to the interior surface 112 of the component encasing wall 102. In yet another embodiment, the component elevating feature 104 is an angled ramp integral to the interior surface 112 of the component encasing wall 102. In still another embodiment, the component elevating feature 104 is an angled ramp and the front of the angled ramp has a beveled edge such that if a component comes into contact with the beveled edge it will slide up and along the angled ramp.

### Operation

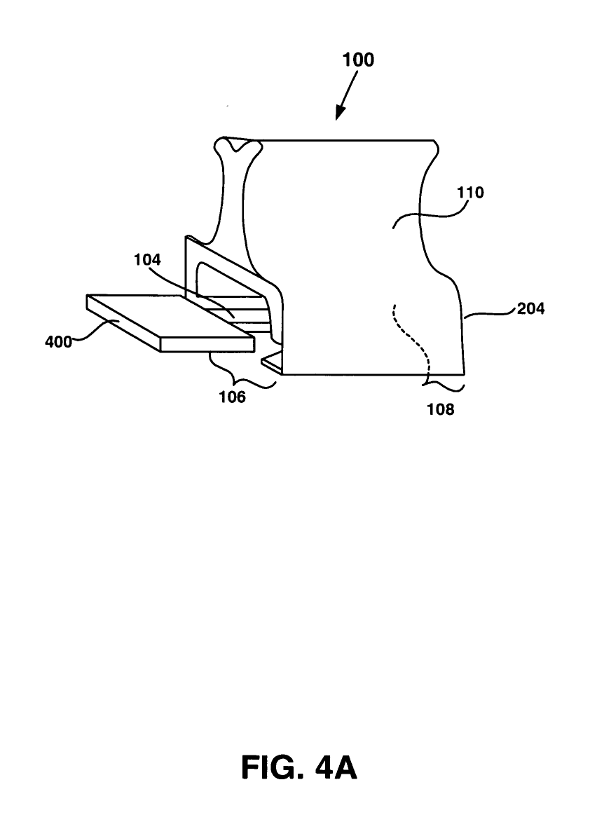

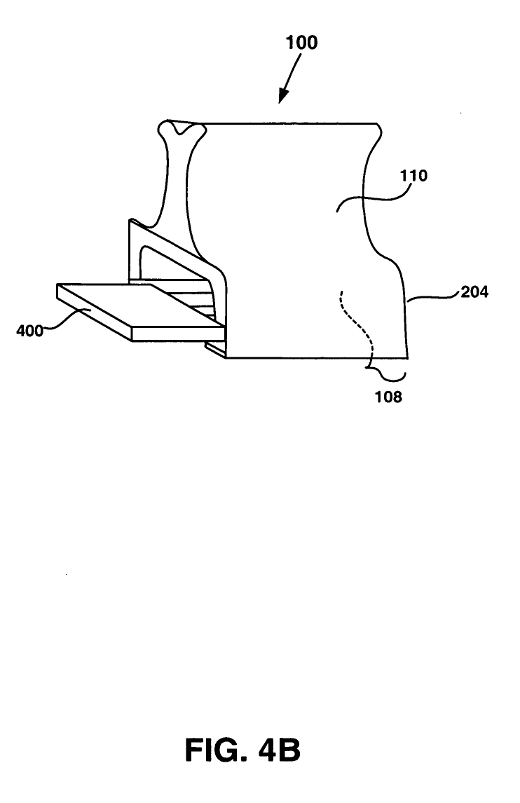

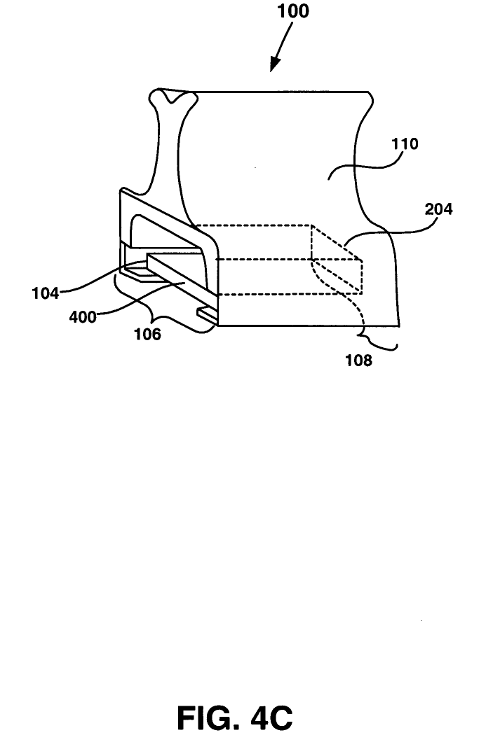

FIGS. 4A thru 4C illustrate a specific embodiment of the present invention in operation.

As shown in FIG. 4A, the first opening of the component handling device 100 is properly aligned with respect to a component 400 to be detached. Use of the component handling device 100 typically involves aligning the first opening 106 with the component 400. As shown in FIG. 4B, the component elevating feature 104 slides under and along the component 400 to detach the component 400 from a substrate.

Component handling device 100 further enables a user to visually inspect whether the component 400 has been locked in place. If the component 400 has been locked in place it will not rattle or move about when the user moves the component handling device 100. Thus, the present invention allows a user to easily check whether the component 400 has been locked in place to prevent accidentally dropping the component 400.

For purposes of the present invention, the component 400 can be many things. For example, the component 400 can be a type of integrated circuit such as a memory module, an audio amplifier, a timer, a switch, or a microprocessor. In addition, the component 400 can be an electrical device such as an oscillator. Also, the component 400 may be a non-electrical device. For example, the component 400 can be a plastic part mounted on a surface.

Regardless of what the component 400 is, it may be difficult or even dangerous to manually detach the component 400 from a substrate. For example, the component 400 may be an oscillator operating at a high temperature that makes manual detachment impossible. An attempted manual removal of the heated component 400 will cause severe burns. The component handling device 100 serves as a physical barrier between a user's hand and the heated component 400. Accordingly, a user may safely remove the component 400 without the risk of being burned. Hence, the present invention allows a user to remove a component 400 safely by providing a means to remove the component 400 operating at a high temperature without having to come into direct physical contact of the heated component 400.

Moreover, although in some situations the user may be able to wait until the component 400 cools sufficiently to allow safe manual removal, in certain emergency circumstances a user may need to remove a heated component 400 immediately from the substrate. For example, an overheating component 400 may cause damage to the substrate and the overheating component 400's surrounding parts. Alternatively, the substrate may be incompatible with the component 400 and is causing the component 400 to overheat. In both situations, the user would not have the option of waiting until the component 400 cools. Hence, the present invention is beneficial because it allows a user to remove a heated component 400 safely and without having to wait. In addition, even if waiting for the component 400 to cool is a viable option, a user may find it undesirable to spend time waiting for a component 400 to cool down. Thus, the present invention will enable a user to save time and become more efficient.

Also, another disadvantage of manually detaching a component 400 is that parts are being packed more tightly and removal by hand is becoming increasingly difficult. As technology progresses, parts have continued to decrease in size and more parts are being packed into the same amount of space in order to improve performance. For example, the size of notebook computers have continued to decrease or remain the same while more parts are being crammed into each computer. By doing so, a notebook computer of the same size as before is able to possess greater processing power. However, as a result of tighter packing of parts, in many instances, both the location and size of a component 400 contribute to the difficulty of properly reaching and detaching the component 400 by hand.

For example, a small and flat component 400 that vertically extends merely a few millimeters from a motherboard and located in a narrow canyon-like region between two tall SIMMs may need to be removed. The height to width ratio of the canyon-like region may make it difficult or even impossible for a human hand to reach in and remove the component 400. And if a user's only option would be to remove the SIMMs first before removing the component 400 located in between, extra time would be taken up and the user's efficiency will suffer. Alternatively, if a user were to attempt to remove the component 400 manually regardless of its awkwardness or difficulty, the user's hand might end up causing damage to surrounding parts.

Hence, the present invention allows a user to access and remove a component 400 that is previously unreachable. The component handling device 100 itself is compact and a user may hold on to a tall and narrow user gripping feature 101 and guide it with ease through narrow canyon-like regions. For instance, because the component handling device 100 can be made to be the same width as the component 400 itself, a user may hold on to the tall and narrow user gripping feature 101 and guide the component handling device 100 into the narrow canyon-like regions between two tall SIMM cards to remove the component 400. Thus, the present invention enables a user to reach and remove a component 400 positioned in tightly crammed locations. Furthermore, the present invention enables a user to reach and remove the component 400 with lowered risk of damaging surrounding parts.

Additionally, the component handling device 100 serves as a barrier between one's hand and the sharp edges on some parts that could cut a person's skin during manual detachment. Hence, the present invention will help to reduce cuts during manual removal of a component 400.

Moreover, because now a user has the additional flexibility of reach provided by the present invention, the component handling device 100 enables one to pack even more parts into the same amount of space. And by allowing part density to increase, a further increase in efficiency can be achieved. For example, because of the present invention, a user may be able to fit more parts into a computer. Hence, the present invention allows a further increase in computing power per amount of space.

Aside from allowing a further increase in computing power, the present invention also has other benefits. For instance, the attachment between the component 400 and the substrate may be too strong to permit manual detachment. Also, in conventional approaches, manual removal of a component 400 often involves an uneven and imprecise allocation of force between fingers. The difference forces applied towards the component 400 by different fingers may cause the component 400 to bend or even break. In contrast, by having a component elevating feature 104, a smaller amount of force is needed to remove the component 400 from the substrate. Also, an even and precise allocation of force is achieved. For example, in one embodiment, the component elevating feature 104 is an angled ramp. By using an angled ramp, additional leverage is provided to the user. Thus, less force is needed to lift a component 400 off from a substrate. Also, the separation force is evenly distributed and equally delivered to the component 400 by the angled ramps. Hence, the present invention allows a user to exert less force to remove a component 400 from a substrate. Also, the present invention allows a user to apply the separation force evenly to reduce the risk of breaking the component 400 during removal.

In conventional approaches, an additional concern is whether or not the force supplied by a user's hand can be effectively applied towards removing the component 400 from a substrate. Thus, in contrast to conventional approaches, in one embodiment, the user gripping feature 101 is a centrally aligned Y-shaped handle that provides an ergonomic counter surface for a person's fingers to exert force against, thus improving the security of the grip while making it less demanding to apply force towards removing the component 400. Moreover, in another embodiment, the central alignment of the user gripping feature 101 provides balance to effectively transfer the force from the user gripping feature 101 to the body 110 of the component handling device 100. Thus, the present invention provides an ergonomic way for the user to effectively apply force towards removing a component 400 from a substrate.

In conventional approaches, a concern that often arises is that static charge accumulated on a person presents a danger of harming both the component 400 and the substrate. Without proper insulation during manual detachment of a component 400, static charge can flow from a person to the component 400 and the substrate. If this occurs, both the component 400 and the substrate itself could be severely damaged. In contrast to conventional approaches, in one embodiment, the component handling device 100 is comprised of a material that dissipates static charge. Consequently, the static charge on the user will be dissipated by the component handling device 100 and will not flow to and damage the component 400 or the substrate. Hence, the present invention allows a user to safely remove a component 400 without the risk of static charge damage.

Additionally, as shown in FIG. 4C, during detachment, as the component 400 moves up the component elevating feature 104 and towards the second opening 108 it will be blocked from exiting through the second opening 108 by the component bounding feature 204 (hidden). Also, the component 400 will be secured within the component handling device 100 by the component retaining feature 200 (hidden).

In conventional approaches, a common concern is that the component 400 may slip and fall during manual detachment, in which instance, both the component 400 and the substrate may be damaged. In contrast, the present component handling device 100 is equipped with a component retaining feature 200. In one embodiment, the component retaining feature 200 is a detent. When the component 400 is properly placed inside the component handling device 100, the detent will be engaged and assist with retaining the component. Also, the component handling device 100 is equipped with a component bounding feature 204. In one embodiment, the component bounding feature 204 is a wall that partially covers the second opening. When the component 400 is properly placed inside the component handling device 100, the wall will prevent the component 400 from accidentally exiting through the second opening. Thus, when the user moves the component handling device 100 about, the component 400 within will be less likely to fall out and be damaged. Hence, the present invention allows a user to securely retain the component 400 within the component handling device 100.

In conventional approaches, after manual detachment, it is possible that the component 400 may collide with other parts, in which instance, both the component 400 and the parts may be damaged. Conversely, in one embodiment, the component handling device 100 has a component encasing wall 102 that substantially encloses the component 400. The component encasing wall 102 acts as a barrier and protects the component from colliding with other parts during removal. Hence, the present invention reduces the risk of the component 400 colliding with other parts by protecting the component 400 with a component encasing wall 102.

Also, after detachment, a person may desire to leave the component handling device 100 on an operating component 400 for more than just a brief period. However, with conventionally approaches, an operating component 400 will unavoidably generate heat and the component encasing wall 102 will contribute to trapping the heat and thus lead to a possibly intolerable increase in temperature. Thus, conversely, in one embodiment there are airflow holes 202 located on the component bounding feature 204. These airflow holes 202 enable heated air to escape and assist in the cooling of a component 400 inside the component encasing wall 102.

The airflow holes 202 may help to increase a user's efficiency in certain situations. For example, a component 400 may be temporarily removed from a first substrate for the purpose of being coupled with a second substrate in order to test the component 400. In this situation, it would save time if a user can simply remove the component 400 from the first substrate with the component handling device 100, retain the component 400 within the component handling device 100, couple the component 400 directly with the second substrate without removing the component 400 from the component handling device 100, and then return the component 400 to the first substrate. This would not be feasible if retaining the component 400 inside the component handling device 100 would cause the component 400 to overheat when it is coupled with the second substrate. However, the airflow holes 202 may make this possible because it provides an additional mean for heat to escape.

Hence, the present invention allows a component 400 to cool off even while it is retained within the component handling device 100. Moreover, the present invention allows the user to function more efficiently by making it feasible to retain the component 400 within the component handling device 100 while performing various tasks.

### Method of Manufacturing a Component Handling Device

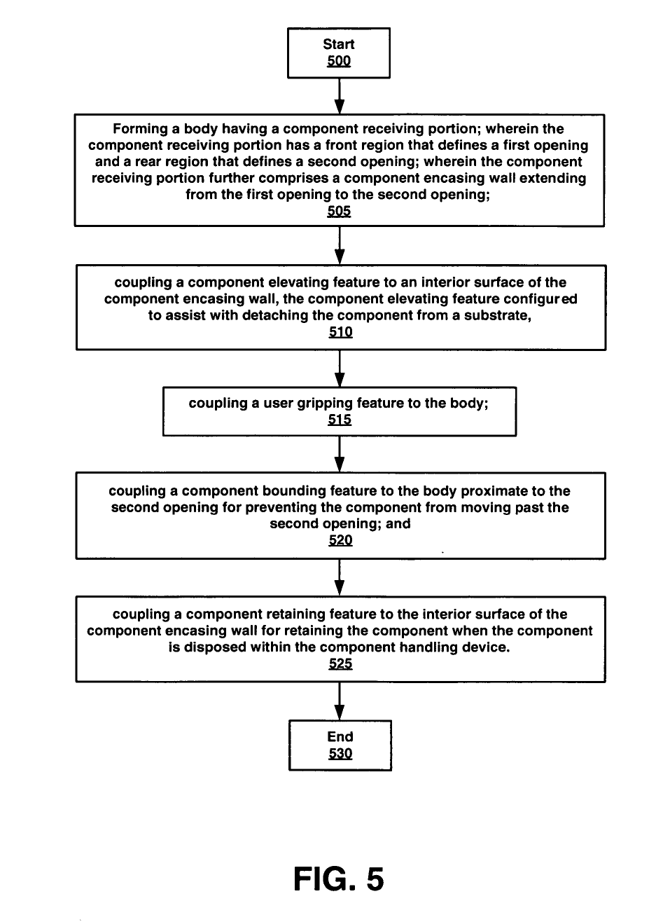

FIG. 5 illustrates a flow chart showing a method of manufacturing a component handling device 100. At block 500, the process starts. At block 505, a body 110 having a component receiving portion is formed. The component receiving portion has a front region that defines a first opening 106 and a rear region that defines a second opening 108. The component receiving portion further comprises a component encasing wall 102 extending from the first opening 106 to the second opening 108. At block 510, a component elevating feature 104 is coupled to an interior surface 112 of the component encasing wall 102. The component elevating feature 104 is configured to assist with detaching the component 400 from a substrate. At block 515, a user gripping feature 101 is coupled to the body 110. At block 520, a component bounding feature 204 is coupled to the body 110 proximate to the second opening 108 for preventing the component 400 from moving past the second opening 108. At block 525, a component retaining feature 200 is coupled to the interior surface 112 of the component encasing wall 102 for retaining the component 400 when the component 400 is disposed within the component handling device 100. At block 530, the process ends.

In one embodiment, coupling a component elevating feature 104 to an interior surface 112 of the component encasing wall 102 comprises coupling an angled ramp to an interior surface 112 of the component encasing wall 102. In another embodiment, forming the body 110 having a component receiving portion comprises forming the body 110 of a material that dissipates static charge. In another embodiment, coupling the component bounding feature 204 to the body 110 proximate to the second opening 108 for preventing the component 400 from moving past the second opening 108 further comprises coupling a component bounding feature 204 having a plurality of airflow holes 202 to the body 110 proximate to the second opening 108 for preventing the component 400 from moving past the second opening 108. In still another embodiment, coupling a user gripping feature 101 to the body 110 comprises coupling a user gripping feature 101 including a Y-shaped handle to said body 110. In yet another embodiment, coupling a component retaining feature 200 to the interior surface 112 of the component encasing wall 102 for retaining the component 400 when the component 400 is disposed within the component handling device 100 further comprises coupling a component retaining feature 200 including a detent to the interior surface 112 of the component encasing wall 102 for retaining the component 400 when the component 400 is disposed within the component handling device 100.

The present invention is well suited to various means of manufacturing. For example, a component handling device 100 can be made by extrusion, die casting, compression molding, injection molding, reaction injection molding, blow molding, vacuum forming, or fabrication.

Also, in one example, a component handling device 100 can be manufactured by assembling various parts and pieces together. For instance, an angled ramp can be manufactured separately and then later glued onto the component encasing wall 102. Alternatively, all parts of a component handling device 100 can be manufactured in one process. For instance, all parts of a component handling device 100 can be manufactured by injection molding.

What is claimed is:

1. A component handling device comprising:
a body having a component receiving portion; wherein said component receiving portion has a front region that defines a first opening and a rear region that defines a second opening; wherein said component receiving portion further comprises a component encasing wall extending from said first opening to said second opening;
a component elevating feature coupled to an interior surface of said component encasing wall, said component elevating feature configured to assist with detaching said component from a substrate,
a user gripping feature coupled to said body;
a component bounding feature proximate to said second opening and coupled to said body for preventing said component from moving past said second opening; and
a component retaining feature coupled to said interior surface of said component encasing wall for retaining said component when said component is disposed within said component handling device.

2. The component handling device of claim 1, wherein said component elevating feature comprises:
an angled ramp that is configured to detach said component from said substrate as said angled ramp is slid under and along said component.

3. The component handling device of claim 1, wherein said component handling device is comprised of a material that dissipates static charge.

4. The component handling device of claim 1, wherein said component bounding feature further comprises:
a plurality of airflow holes.

5. The component handling device of claim 1, wherein said user gripping feature further comprises:
a Y-shaped handle.

6. The component handling device of claim 1, wherein said component bounding feature is comprised of a wall that entirely encloses said second opening

7. The component handling device of claim 1, wherein said component retaining feature comprises:
a detent coupled to said interior surface.

8. A method of manufacturing a component handling device comprising:
forming a body having a component receiving portion; wherein said component receiving portion has a front region that defines a first opening and a rear region that defines a second opening; wherein said component receiving portion further comprises a component encasing wall extending from said first opening to said second opening;
coupling a component elevating feature to an interior surface of said component encasing wall, said component elevating feature configured to assist with detaching said component from a substrate,
coupling a user gripping feature to said body;
coupling a component bounding feature to said body proximate to said second opening for preventing said component from moving past said second opening; and
coupling a component retaining feature to said interior surface of said component encasing wall for retaining said component when said component is disposed within said component handling device.

9. A method of manufacturing a component handling device as recited in claim 8, wherein said coupling a component elevating feature to an interior surface of said component encasing wall comprises:
coupling an angled ramp to said component encasing wall, wherein said angled ramp is configured to detach said component from said substrate as said angled ramp is slid under and along said component.

10. A method of manufacturing a component handling device as recited in claim 8, wherein said forming a body having a component receiving portion comprises:
forming said body of a material that dissipates static charge.

11. A method of manufacturing a component handling device as recited in claim 8, wherein said coupling a component bounding feature to said body proximate to said second opening for preventing said component from moving past said second opening further comprises:
coupling a component bounding feature having a plurality of airflow holes to said body proximate to said second opening for preventing said component from moving past said second opening.

12. A method of manufacturing a component handling device as recited in claim 8, wherein said coupling a user gripping feature to said body further comprises:
coupling a user gripping feature including a Y-shaped handle to said body.

13. A method of manufacturing a component handling device as recited in claim 8, wherein said coupling a component retaining feature to said interior surface of said component encasing wall for retaining said component when said component is disposed within said component handling device further comprises:
coupling a component retaining feature including a detent to said interior surface of said component encasing wall for retaining said component when said component is disposed within said component handling device

14. A component handling device comprising:
component receiving means for receiving a component; wherein said component receiving means has a front region that defines a first opening and a rear region that defines a second opening; wherein said component receiving means further comprises a component encasing wall extending from said first opening to said second opening;
component elevating means coupled to an interior surface of said component encasing wall, said component elevating means for assisting with detaching said component from a substrate,
user gripping means coupled to said body for the user to hold on to said component handling device;
component bounding means proximate to said second opening and coupled to said body for preventing said component from moving past said second opening; and
component retaining means coupled to said interior surface of said component encasing wall for retaining said component when said component is disposed within said component handling device.

15. The component handling device of claim 14, wherein said component elevating means comprises:
an angled ramp that is configured to detach said component from said substrate as said angled ramp is slid under and along said component.

16. The component handling device of claim 14, wherein said component handling device is comprised of:
a material that dissipates static charge.

17. The component handling device of claim 14, wherein said component bounding means further comprises:
a plurality of airflow holes.

18. The component handling device of claim 14, wherein said user gripping means further comprises:
a Y-shaped handle.

19. The component handling device of claim 14, wherein said component bounding means is comprised of:
a wall that entirely encloses said second opening

20. The component handling device of claim 14, wherein said component retaining means comprises:
a detent coupled to said interior surface of said component encasing wall.
